(19) United States
(12) Patent Application Publication
(10) Pub. No.: US 2017/0154167 A1
(43) Pub. Date: Jun. 1, 2017

(54) A SYSTEM AND A RELATED METHOD FOR AUTOMATICALLY SELECTING A HANGING PROTOCOL FOR A MEDICAL STUDY

(71) Applicant: AGFA HEALTHCARE INC., Toronto (CA)

(72) Inventor: Alexandre OVTCHINNIKOV, Mississauga (CA)

(21) Appl. No.: 15/309,822

(22) PCT Filed: May 12, 2015
(86) PCT No.: PCT/EP2015/060409

§ 371 Date: Nov. 9, 2016

(30) Foreign Application Priority Data
May 13, 2014 (EP) 14168037.1

(51) Int. Cl. G06F 19/00; G06F 17/30

(52) U.S. Cl. CPC G06F 19/363; G06F 17/3053

(57) ABSTRACT

A system (100) for selecting a selected hanging protocol (201) for a medical study includes a memory to store hanging protocols and to store a credibility factor for each of the hanging protocols; a selection engine adapted to combine a calculated matching score between each of the hanging protocols and the medical study with the credibility factor, thereby defining a relevance score for each of the hanging protocols, and to select the hanging protocol with the highest relevance score as the selected hanging protocol.

### CROSS REFERENCE TO RELATED APPLICATIONS

This application is a 371 National Stage Application of PCT/EP2015/060409, filed May 12, 2015. This application claims the benefit of European Application No. 14168037.1, filed May 13, 2014, which is incorporated by reference herein in its entirety.

### BACKGROUND OF THE INVENTION

1. Field of the Invention

The present invention generally relates to the automatic selection of hanging protocols for use in a picture archiving and communication system or PACS used in e.g. a medical imaging environment.

A picture archiving and communication system (PACS) is a medical imaging technology which provides economical storage of and convenient access to images from multiple modalities. Electronic images and reports are transmitted digitally via PACS. This eliminates the need to manually file, retrieve, or transport film jackets. Non-image data, such as scanned documents, may be incorporated using consumer industry standard formats, for instance in PDF (Portable Document Format). A PACS consists of four major components: imaging modalities such as for example X-ray plain film (PF) or computed tomography (CT) or magnetic resonance imaging (MRI) devices, a secured network for the transmission of patient information, workstations for interpreting and reviewing images, and archives for the storage and retrieval of images and reports.

A hanging protocol is the series of actions performed by the PACS to select and/or arrange images of a medical study for optimal softcopy viewing by a user. The term includes the concept of displaying softcopy images on a PACS workstation. The goal of a hanging protocol is to present specific medical studies in a consistent manner, and to reduce the number of manual image ordering adjustments performed by a user of the PACS, for instance a radiologist. Hanging protocols vary based on modality, body part, department, personal preference, and even training. On a full-featured PACS workstation, an appropriate hanging protocol is automatically applied based on the characteristics of the study being loaded. Information such as modality, body part, medical study or series description must be available to ensure proper selection of the hanging protocol. In addition, information such as image orientation and patient positioning must be available to organize the images properly. Most PACS workstations allow hanging protocols to be customized by each user, and some systems store hanging protocols at a central location, making them available at any workstation accessed by a particular radiologist or other authorized user.

2. Description of the Related Art

In a medical environment, a typical workflow when a patient is investigated consists in producing images, for instance an X-ray plain film (PF) or computed tomography (CT) or magnetic resonance imaging (MRI) images or previous reports of the patient coming from other medical departments or a report from a laboratory, to send them to the PACS, to analyze them and report the diagnosis to the patient. A hanging protocol is the series of actions performed to select and/or arrange the images for optimal softcopy viewing. In other words, the images acquired by the PACS from medical devices are selected and/or arranged according to a specific order before being displayed to the user. The order is specific to a hospital, and is therefore not based on a national or international policy. The images can be manually arranged, but if an image is swapped, the risk for the specialist, for instance a radiologist, to come up with a wrong diagnosis increases. When the complete data does not fit on a monitor, the specialist must switch between different images in order to access all the relevant information. Also, the switching order forms part of the hanging protocol. For instance, the specialist can switch between images presenting a different density, like bones or tissues. Manually switching between images is time consuming and subject to error. Also, the technician in charge of displaying the images needs to constantly adapt a set of new rules in order to match the incoming data, which drastically increases the number of parameters.

US2012/0189180 describes a method for determining a hanging protocol for a medical study. The method consists in capturing certain characteristics for the medical study based on relationships between images in the study. The characteristics can comprise a detection method, i.e. a comparison with a previously studied medical study, or a perspective view of a dataset, or a 3D extrapolation of a 2D image. It can further comprise a comparison of the image resolution vs. the resolution of monitor of the workstation. The determination of the hanging protocol is based on a classification of the characteristics of the medical study, and the adaptation of the hanging protocol is based on a stored hanging protocol created by the user.

According to the detection method described in US2012/0189180, it is possible to display a given medical study in a certain location. This means that the provided hanging protocol will be different from one workstation to another, for example depending on the resolution of the monitor of the workstation. The relationships between the images of the medical study are used to determine the display locations of the images. An initial hanging protocol can for instance be used to learn how a particular user likes to display images. The information can be obtained/stored so that it can be reproduced later as a hanging protocol depending on a matching score between the images of the later medical study and the stored hanging protocol used in a previous session. A user, for example a radiologist, can review, approve, and/or make changes to the saved hanging protocol information.

The method for determining a hanging protocol for a medical study known from US2012/0189180 includes monitoring the user workflow in a first session. Input from the user is accepted to record/teach at least a portion of the workflow that will be repeated in a second session. A set of user preferences are developed based on the monitoring and the user input. One or more machine learning algorithms will be applied to determine one or more candidate hanging protocols and refine the selection based on the user preferences ending up with a hanging protocol that will eventually be used during the analysis of the images of the medical study. Even though this method brings flexibility to the analysis of the medical study and meets the expectation of individual users, the fact that each user can display the images according to his preferences might result in several diagnosis for the same medical study. The personalization of the hanging protocol creates a risk to come up with a wrong diagnosis, which dramatically delays the treatment of the patient and eventually threatens his integrity. The method does not bring consistency throughout an organisation in for instance analyses of medical studies or reporting of the conclusions.

US2008/0166070 describes a method for selecting a hanging protocol based on efficiency of use. The method consists in monitoring usage information for a hanging protocol, where the usage information includes the selection of a hanging protocol and a change to the hanging protocol by a first user during the reading of the images of the medical study. A productivity factor based on efficiency of the first user is determined during the reading of the images of the medical study. Based on this productivity factor, a hanging protocol is recommended to a second user along with a change of the hanging protocol.

The best existing solution is known from US2008/0166070. US2008/0166070 describes a method that relies on a productivity factor representative of the efficiency of a user in reading or making a diagnosis based on a medical study using a particular hanging protocol and/or set of change(s) to the protocol. The productivity factor can vary based on the efficiency of different users using different hanging protocols. In other words, while two different users may both be equally adept and competent in their reading of a particular medical study, the efficiencies of these users may differ based on each user employing different hanging protocols to read the medical study. The productivity factor is a numerical indicator of this relative efficiency. As a consequence, the system known from US2008/0166070 shall recommend a different hanging protocol for each other, selected in order to maximize his efficiency during the analysis of the medical study. The selected hanging protocol is chosen with respect to the identity of the user and is not based on the relevancy of the hanging protocol for the particular medical study. As the images of the medical study are presented in a different order and/or manner for each user, the conclusions and diagnosis drawn by different users for a single medical study can differ. The differences in the way the images are displayed to several users threatens their objectivity and their efficiency. It further creates a risk to come up with several diagnosis for the same medical study or even worse a wrong diagnosis, which dramatically delays the treatment of the patient and eventually threatens his integrity.

The system known from US2008/0166070 is disadvantageous because it does not force different users of the same organisation to use the same hanging protocol. Also, it does not harmonize the way a medical study is analysed in a given organization. The system does not benefit from the experience of users in a given organization. In other words, younger or less experienced users of the system are presented images in accordance with their abilities or efficiency, as a result of which they do not learn from older or more experienced users. The system does not converge to a preferred protocol that is imposed upon an organization.

### SUMMARY OF THE INVENTION

It is an objective of the present invention to disclose a system and the related method that overcome the above identified shortcomings of existing tools. More particularly, it is an objective to disclose such system and method for automatically selecting a reliable hanging protocol for a given medical study in order to bring uniformity in the way the medical study is displayed for analysis within for example a medical department or a hospital, thereby reducing the risk of a delay in the diagnosis or even a false diagnosis. It is a further objective to disclose such a system that enables the selection of such a hanging protocol in a fast and efficient manner.

According to a first aspect of the present invention, the above defined objectives are realized by a system for automatically selecting a selected hanging protocol for a medical study as defined below.

Specific and/or preferred embodiments are also set out below.

Just like known systems, the selection engine according to a preferred embodiment of the present invention calculates a matching score between each of the hanging protocols and the medical study based on characteristics of the medical study. Each hanging protocol is indeed characterized by a set of features specifying the context wherein the hanging protocol has been created. For instance, the set of features comprises the type of medical study (PET scan, MRI scan, CT scan, etc), the size of the images, the contrast of the images, the zoom on an image or on a graph, metadata such as the name and the age of the patient, etc. The characteristics of the medical study under consideration are compared to the set of features of the hanging protocols stored in the hanging protocol memory. A selection engine calculates a matching score, which indicates how close the characteristics of the medical study are to the set of features of the hanging protocol. In other words, the matching score is an indication of how similar the characteristics of a medical study are to the ones of a previous medical study for which the considered hanging protocol has been created and configured. The larger the number of similarities between the medical study, or the series, and the set of features of the considered hanging protocol, the higher the matching score. The matching score can for example be an integer, or a floating number, or a floating number comprised between 0 and 100 and preferably between 0 and 1.

In accordance with a preferred embodiment of the present invention, credibility factors for each hanging protocol are stored in a credibility memory. The credibility factor of a hanging protocol initially is derived from a set value inherent to the creator of the considered hanging protocol. This set value is an indication of the credibility of the creator of the considered hanging protocol. The creator's credibility may be determined by one or more of the following elements : the creator's age, the number of medical studies reported by the creator, the speed at which the creator reports a medical study, the amount of time the creator uses the system, the number of hanging protocols stored in the hanging protocol memory and created by this person, the number of times each of the hanging protocols create by this creator are used with and/or without changes applied by other users, etc. The credibility factor further may become updated in view of acceptance of the hanging protocol by the users of the system. In accordance with a preferred embodiment of the present invention, the selection engine is adapted to combine the matching score with the credibility factor for each hanging protocol. The combination operation can consist for example in the calculation of a product of the matching score and the credibility factor, and results in the definition of a relevance score for each hanging protocol. The relevance score is by definition an indication of how relevant the considered hanging protocol is for a given medical study. It is an indication of the relevancy, the experience, the accuracy and the acceptance by the community of the hanging protocol. The selection engine according to a preferred embodiment of the present invention is further adapted to select and recommend to the user the hanging protocol for which the relevance score is the highest. This way, a user is being recommended a hanging protocol in a fast, relevant and efficient manner. The selection and the recommendation of the hanging protocol takes the experience of other users of the system into account. Younger or less experienced users take benefit from older or more experienced users. On a long term basis, the system according to a preferred embodiment of the present invention forces different users of the system belonging to the same organisation, for example the same medical department or the same hospital, to use the same hanging protocol for a given medical study. The selected hanging protocol is the one that meets the highest acceptance within the community of users for this type of medical study. This way, a given medical study is systematically analysed according to the same sequence within an organization. The way specialists analyse information from the medical study is harmonized, since the system converges to a uniform way of displaying images. Indeed, on a long term basis, a preferred selected hanging protocol per given medical study will be recommended and will be imposed within an organization such as a medical department or a hospital. This way, risks of delaying the diagnosis, or risks of performing a wrong diagnosis are lowered within a medical department or a hospital.

It is noted that medical imaging in the context of the present invention should be interpreted such as the technique, process and art of creating visual representations of the interior of a body for clinical analysis and medical intervention, related to a patient, in order to perform a diagnosis. Medical imaging seeks to reveal internal structures hidden by the skin and bones, as well as to diagnose and treat disease. It is part of biological imaging and incorporates for example radiology which uses the imaging technologies of X-ray radiography, magnetic resonance imaging, medical ultrasonography or ultrasound, endoscopy, elastography, tactile imaging, thermography, medical photography and nuclear medicine functional imaging techniques as positron emission tomography. Measurement and recording techniques which are not primarily designed to produce images, such as for example electroencephalography (EEG), magnetoencephalography (MEG), electrocardiography (EKG), and others, but which produce data susceptible to be represented as a parameter graph vs. time or maps which contain information about the measurement locations, can be considered as forms of medical imaging within the context of the present invention. A medical study can therefore consist in for example running a CT scan or a Positron Emission Tomography (PET) scan, or combining several results from several different scans. In a given medical study, several series can exist, which provide the specialist with more technical information on how the images were acquired. For instance, a series can indicate if a PET scan has been attenuated or non-attenuated. Medical images of a patient are being acquired during the medical study and will be investigated in order to perform a diagnosis.

According to an optional preferred embodiment, the system according to the present invention further comprises:
a usage monitor unit adapted to monitor usage of the selected hanging protocol by a user, and adapted to modify the credibility factor of the selected hanging protocol in function of the usage.

In accordance with a preferred embodiment of the present invention, the credibility factor associated to the selected hanging protocol and the credibility memory are dynamically adapted and updated according to the user's usage of the selected hanging protocol. The credibility memory is therefore up-to-date on the acceptance of each selected hanging protocol by the community of users. For example, the selection engine selects a hanging protocol for a given medical study and recommends it to a user. If the user uses the selected hanging protocol without modifying it, the usage monitor unit does not detect a change to the selected hanging protocol. It is an indication that the user considers this selected hanging protocol as relevant, fast, trustworthy, and/or efficient for the analysis of the medical study. On the contrary, if the usage monitor unit detects a change performed by the user in the selected hanging protocol, it is an indication that for this medical study, the acceptance of the hanging protocol is lower. The credibility factor of each hanging protocol is systematically modified when it is selected and in function of its usage by a user. The selection procedure performed by the selection engine is therefore constantly improving. Modifying the credibility factor of a hanging protocol modifies its relevance score. The selection engine according to a preferred embodiment of the present invention is selecting and recommending hanging protocols based on the relevance score that takes feedback of the community of users on the hanging protocols into account. On a long term basis, the system according to a preferred embodiment of the present invention shall force different users of the system belonging to the same organisation, for example the same medical department or the same hospital, to use the same hanging protocol for a given medical study, more particularly the hanging protocol that is best accepted by the user community. A preferred selected hanging protocol per given medical study will be recommended and will be imposed within an organization such as a medical department or a hospital. This way, risks of delaying the diagnosis, or risks of performing a wrong diagnosis are lowered within a medical department or a hospital.

According to an optional preferred embodiment, the system according to the present invention is further characterized in that the usage monitor unit is adapted to increase the credibility factor of the selected hanging protocol in case the selected hanging protocol is left unchanged by said user.

In accordance with a preferred embodiment of the present invention, when the selection engine has selected a hanging protocol that the user has not modified, the usage monitor does not detect any change to the selected hanging protocol. This is an indication that the user considers this selected hanging protocol as for example relevant, and/or fast, and/or trustworthy, and/or efficient for the analysis of the medical study. Therefore, the usage monitor increases the credibility factor of the selected hanging protocol and updates the value of the credibility factor associated with the selected hanging protocol in the credibility memory. Next time a similar medical study needs analysing, the hanging protocol will present a higher relevance score and the probability that this hanging protocol is selected increases.

According to an optional preferred embodiment, the system according to the present invention is further characterized in that the usage monitor unit is adapted to decrease the credibility factor of the selected hanging protocol in case the selected hanging protocol is changed by the user.

In accordance with a preferred embodiment of the present invention, when the selection engine has selected a hanging protocol that the user has modified, the usage monitor detects one or more change(s) to the selected hanging protocol. This is an indication that the user considers this selected hanging protocol for example not relevant enough, and/or not fast enough, and/or not trustworthy enough, and/or not efficient enough for the analysis of the medical study. Therefore, the usage monitor decreases the credibility factor of the selected hanging protocol and updates the value of the credibility factor associated with the selected hanging protocol in the credibility memory. Next time a similar medical study needs analysing, the hanging protocol will present a lower relevance score and the probability that this hanging protocol is selected decreases.

According to an optional preferred embodiment, the system according to the present invention further comprises:
a modification recording unit adapted to record changes applied by the user to the selected hanging protocol, thereby creating a new hanging protocol, and to store the new hanging protocol in the hanging protocol memory; and
a credibility factor initializer adapted to initialize a new credibility factor for the new hanging protocol representative for the credibility of the user and to store the new credibility factor in the credibility memory.

In accordance with a preferred embodiment of the present invention, the user of the system can create and configure one or several hanging protocols, and is then referred to as the creator of these hanging protocols. For example, a user of the system is busy with a medical study for which no hanging protocol is stored in the hanging protocol memory. In other words, there exist no hanging protocol in the hanging protocol memory that can be used to display the images of the medical study. The user then has the possibility to start configuring a hanging protocol from scratch in order to display the images of the medical study, to store it in the hanging protocol memory, and is thereby referred to as the creator of this hanging protocol. In another realization, the user of the system can also use an existing hanging protocol stored in the hanging protocol memory to display the images of the medical study. However, the user might not be satisfied with the way the images are displayed in terms for example of size, zoom or resolution, or the user might need to add/remove images or plots. The user might consider this selected hanging protocol for example not relevant enough, and/or not fast enough, and/or not trustworthy enough, and/or not efficient enough for the analysis of the medical study. The user then has the opportunity to modify a pre-existing hanging protocol stored in the hanging protocol memory and to configure it so that the images of the medical study the user is busy with can be displayed at his convenience. The usage monitor unit detects the changes performed to the selected hanging protocol and the modification recording unit is adapted to record all the changes applied by the user to the selected hanging protocol. These changes may result in the creation of a new hanging protocol that may be stored in the hanging protocol memory. In other words, as soon as the user of the system applies one or more change(s) to the configuration of the selected hanging protocol, a copy of the selected hanging protocol including the change(s) applied by the user is stored in the hanging protocol memory as a new hanging protocol, but the selected hanging protocol stays unchanged and stays stored in the hanging protocol memory. The user of the system is therefore referred to as the creator of the new hanging protocol stored in the hanging protocol memory. This way, the number of hanging protocols stored in the hanging protocol memory increases, which broadens the spectrum of opportunity for the selection engine to select a highly relevant hanging protocol for a given medical study.

In accordance with a preferred embodiment of the present invention, a new hanging protocol can be stored in the hanging protocol memory. The credibility factor of the new hanging protocol may be initialized to correspond with a credibility value of the user, i.e. the creator of the new hanging protocol. This way, the selection engine will be able to calculate a relevance score for the new hanging protocol, and will be able to select the new hanging protocol if its relevance score for a given medical study is the highest.

According to an optional preferred embodiment, the system according to the present invention is further characterized in that the new credibility factor of the new hanging protocol is calculated from one or more of the following parameters:
the age of the user;
the number of medical studies reported by the user;
the speed at which the user reports the study;
the amount of time the user uses the system;
the number of hanging protocols stored in the hanging protocol memory and created by the user; and
the number of times each of the hanging protocols created by the user has been used with and/or without changes applied by users.

In accordance with a preferred embodiment of the present invention, the selection and the recommendation of hanging protocols inherently takes the experience of users of the system into account. Younger or less experienced users are presented images in accordance with the selected hanging protocol, as a result of which they learn from older or more experienced users. The user that modified a hanging protocol and thereby has created a new hanging protocol is referred to as the creator of the new hanging protocol. In accordance with a preferred embodiment of the present invention, the new hanging protocol will get assigned a credibility factor. A credibility factor can for example be an integer, or a floating number, or a floating number comprised between 0 and 100 and preferably between 0 and 1. Initially, the credibility factor is an indication of the credibility of the creator of the new hanging protocol. The more credible the creator of the new hanging protocol, the higher its initial credibility factor. In accordance with a preferred embodiment of the present invention, the initial credibility factor is calculated from one or more parameters. The age of the creator may be an indication of the credibility as a creator of hanging protocols and as a specialist who reports medical studies. The number of medical studies reported by the creator may be an indication of his credibility. The higher the number of medical studies reported by the creator of the new hanging protocol, the higher its credibility factor. The faster the creator reports a medical study to the system using the new hanging protocol, the higher its credibility factor may be. The amount of time the creator of a hanging protocol uses the system may give another indication on the experience of the creator with the system and consequently also of his credibility. The number of hanging protocols stored in the hanging protocol memory and created by the creator may be an indication of the contribution of this creator to the system and of his role in the system as a creator. The higher the number of hanging protocols created by the creator of the new hanging protocol, the higher its credibility factor. The number of times each of the hanging protocols stored in the hanging protocol memory has been used without changes or modifications may be an indication of the acceptance of the creator of these hanging protocols by the community of users of the system. It demonstrates how trustworthy, useful and/or relevant these hanging protocols are considered by the community of users of the system for a given medical study. In other words, it is an indication on the perception of the community of users towards the hanging protocols created by the creator: other users consider they perform a correct, fast and/or an efficient analysis of the images of a medical study when using these hanging protocols. The more the hanging protocols created by a creator are used, the more popular amongst the community of users they become, the higher their credibility factors. If a hanging protocol created by a user is used without changes, the credibility factor of the hanging protocol increases. If a hanging protocol is modified, the credibility factor of the hanging protocol decreases. Obviously, any arbitrary combination of the above described parameters may be used to estimate the credibility of a creator of hanging protocols. The skilled person will also appreciate that the number of parameters that can be used to estimate a creator's credibility is not limited to the above list.

According to an optional preferred embodiment, the system according to the present invention is further characterized in that the hanging protocol memory and the credibility memory are integrated in a single memory.

This way, the system is made less complex as the hanging protocol memory and the credibility memory are forming only one memory. This reduces the cost of the implementation of the system.

According to an optional preferred embodiment, the system according to the present invention is further characterized in that the matching score and the credibility factor are floating numbers between 0 and 1, and characterized in that the selection engine is adapted to multiply the matching score with the credibility factor in order to obtain the relevance score.

This way, the selection engine calculates a combination, preferably a multiplication, of the matching score and of the credibility factor for each hanging protocol, and therefore obtains a relevance score for each hanging protocol. The selection engine then classifies the relevance scores of the hanging protocols in increasing or decreasing order. The selection engine can consequently select the hanging protocol for which the relevance score is the highest, i.e. the hanging protocol for which the relevance score is maximum, i.e. is the largest.

According to an optional preferred embodiment, the system according to the present invention further comprises:
a display rule memory adapted to store display rules for the medical study;
a pre-processing unit adapted to pre-process the medical study according to the display rules, thereby creating a pre-processed medical study; and the system according to the present invention is further characterized in that the selection engine is further adapted to calculate a matching score between each of the hanging protocols and the pre-processed medical study.

This way, a medical study can be pre-processed prior to selecting a hanging protocol. For a given type of medical study, a set of rules can define the way the medical study is going to be pre-processed, and the display rules will be applied by a pre-processing unit. For example, a medical study may be performed in order to study an organic tissue, but the study itself may include an X-ray scan which creates an image where bones are visible. A pre-processing of the medical study may for instance consist in pre-processing the images of the medical study in order to remove the bones from the images so that organic tissues are visible. This way, the selection of the hanging protocol may be done comparing hanging protocol created to study organic tissues to the pre-processed medical study, while the selection of the hanging protocol before pre-processing may have been done comparing hanging protocols created to study bones to the medical study. The selection of the hanging protocol may therefore be improved, and may happen faster.

According to an optional preferred embodiment, the system according to the present invention is further characterized in that the modification recording unit records a change applied by the user to the selected hanging protocol correcting the pre-processed medical study and wherein the system further comprises a rule changing unit adapted to modify the display rules accordingly to the changes recorded by the modification recording unit.

This way, the system may learn from the changes applied by the user to the selected hanging protocol, and consequently may adapt the display rules for pre-processing of the medical study. If the modification recording unit records changes applied by the user to the selected hanging protocol for a pre-processed medical study that counteract the action of an applied display rule, a rule changing unit can modify the applied display rule according to the changes applied by the user. This way, the system takes feedback from the user into account in the definition of the display rules used for pre-processing images of a medical study.

According to a second aspect of the invention, there is a method for automatically selecting a selected hanging protocol for a medical study, the method comprising:
obtaining hanging protocols stored in a hanging protocol memory;
calculating a matching score for each of the said hanging protocols by correlating the medical study with the hanging protocols;
   CHARACTERIZED IN THAT the method further comprises:
obtaining a credibility factor from a credibility memory for each of the hanging protocols;
combining the credibility factor with the matching score for each of the hanging protocols, thereby obtaining a relevance score for each of the hanging protocols;
selecting the hanging protocol with highest relevance score as the selected hanging protocol.

The current invention in addition also relates to a computer program comprising software code adapted to perform the method according to the present invention.

The invention further relates to a computer readable storage medium comprising the computer program according to the present invention.

### BRIEF DESCRIPTION OF THE DRAWINGS

FIG. 1 schematically illustrates a preferred embodiment of the system according to the present invention comprising a hanging protocol memory, a credibility memory, and a selection engine. The selection engine calculates a matching score between a medical study and hanging protocols of the hanging protocol memory. The selection engine further combines the matching score and the credibility factor for each hanging protocol, thereby defining a relevance score for each hanging protocol.

FIG. 2 schematically illustrates a preferred embodiment of the system according to the present invention comprising a hanging protocol memory, a credibility memory, a selection engine, and a usage monitor unit. The usage monitor unit monitors usage by a user of a selected hanging protocol, selected by the selection engine. The user does not modify the selected hanging protocol. The usage monitor unit increases the credibility factor of the selected hanging protocol.

FIG. 3 schematically illustrates a preferred embodiment of the system according to the present invention comprising a hanging protocol memory, a credibility memory, a selection engine, and a usage monitor unit. The usage monitor unit monitors usage by a user of a selected hanging protocol, selected by the selection engine. The user modifies the selected hanging protocol. The usage monitor unit decreases the credibility factor of the selected hanging protocol.

FIG. 4 schematically illustrates a preferred embodiment of the system according to the present invention comprising a hanging protocol memory, a credibility memory, a selection engine, a usage monitor unit, and a modification recording unit. The modification recording unit records changes applied by a user to the selected hanging protocol, thereby creating a new hanging protocol and storing the new hanging protocol in the hanging protocol memory.

FIG. 5 schematically illustrates a preferred embodiment of the system according to the present invention comprising a hanging protocol memory, a credibility memory, a selection engine, a usage monitor unit, a modification recording unit, and a credibility factor initializer. The credibility factor initializer initializes a new credibility factor for the new hanging protocol.

FIG. 6 schematically illustrates a preferred embodiment of the system according to the present invention comprising a hanging protocol memory, a credibility memory, a selection engine, a usage monitor unit, a modification recording unit, and a credibility factor initializer. The selection engine calculates a matching score between a medical study and hanging protocols of the hanging protocol memory, including the new hanging protocol. The selection engine further combines the matching score and the credibility factor for each hanging protocol, thereby defining a relevance score for each hanging protocol, including the new hanging protocol.

FIG. 7 schematically illustrates a preferred embodiment of the system according to the present invention comprising a hanging protocol memory, a credibility memory, a selection engine, a usage monitor unit, a modification recording unit, a credibility factor initializer, a display rule memory, a pre-processing unit and a rule changing unit. The pre-processing unit pre-processes the medical study according to display rules stored in the display rule memory, thereby creating a pre-processed medical study. The selection engine selects the hanging protocol with the highest relevance score. The modification recording unit records a change applied by a user to the selected hanging protocol, correcting said pre-processed medical study. The rule changing unit then modifies the display rules for pre-processing according to the changes recorded by the modification recording unit.

FIG. 8 schematically illustrates a suitable computing system for hosting the system of FIG. 1.

### DETAILED DESCRIPTION OF THE PREFERRED EMBODIMENTS

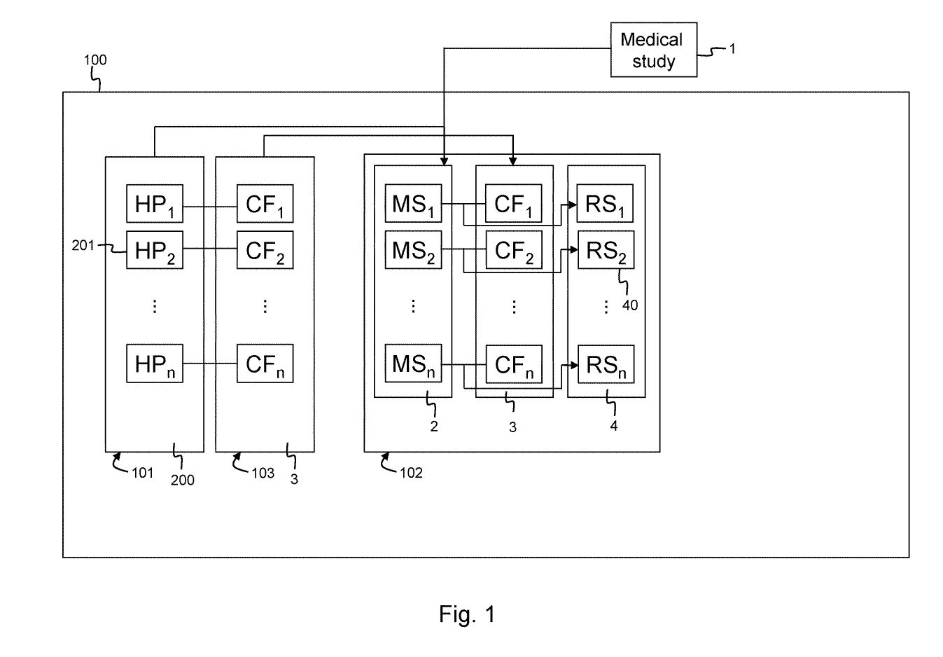

According to a preferred embodiment shown in FIG. 1, a system 100 for automatically selecting a selected hanging protocol 201 for a medical study 1 comprises a hanging protocol memory 101, a credibility memory 103, and a selection engine 102. One or more hanging protocols 200 are stored on the hanging protocol memory 101. For example in FIG. 1, n hanging protocols 200 are stored in the hanging protocol memory 101, numbered from HP₁, HP₂, to HPₙ, where n is an integer higher than 1. To each hanging protocol 200 of the hanging protocol memory 101 is associated a credibility factor 3. The credibility factors 3 are stored in the credibility memory 103, one for each hanging protocol 200. For example in FIG. 1, n credibility factors 3 are stored in the credibility memory 103, numbered CF₁, CF₂, to CFₙ respectively to HP₁, HP₂, and HPₙ, where n is an integer higher than 1. The selection engine 102 compares the medical study 1 to each of the hanging protocols 200 of the hanging protocol memory 101. From this comparison results a matching score 2 between each of the hanging protocols 200 of the hanging protocol memory 101 and the medical study 1. For example in FIG. 1, n matching scores 2 are calculated and numbered MS₁, MS₂ to MSₙ, where n is an integer higher than 1.The selection engine 102 further retrieves from the credibility memory 103 the associated credibility factors 3 of each of the hanging protocols 200. The selection engine 102 then combines for each hanging protocol 200 of the hanging protocol memory 101 the matching score 2 of a hanging protocol and the respective credibility factor 3 of the same hanging protocol. The combination consists for example in calculating the product of the matching score 2 and the credibility factor 3. The combination results in the definition of a relevance score 4. For example in FIG. 1, n relevance scores 4 are calculated from the combination of n credibility factors, numbered CF₁, CF₂, to CFₙ, and n respective matching scores, numbered from MS₁, MS₂ to MSₙ, where n is an integer higher than 1. This therefore results in the definition of n relevance scores 4, numbered from RS₁, RS₂, to RSₙ, where n in an integer higher than 1. The selection engine 2 further classifies the relevance scores 4 of the hanging protocols in increasing order and selects as the selected hanging protocol 201 the hanging protocol for which the relevance score 40 is the highest of all the hanging protocols 200. In other words, the selected hanging protocol 201 is the one for which the relevance score 40 is maximum amongst all the relevance scores 4 calculated by the selection engine 102. In the example depicted in FIG. 1, the highest relevance score 40 for the medical study 1 is calculated for the hanging protocol HP₂ of the hanging protocol memory 101. The hanging protocol HP₂ is selected by the selection engine 102, and therefore becomes the selected hanging protocol 201. It is the selected hanging protocol 201 that will be used to display images of the medical study 1.

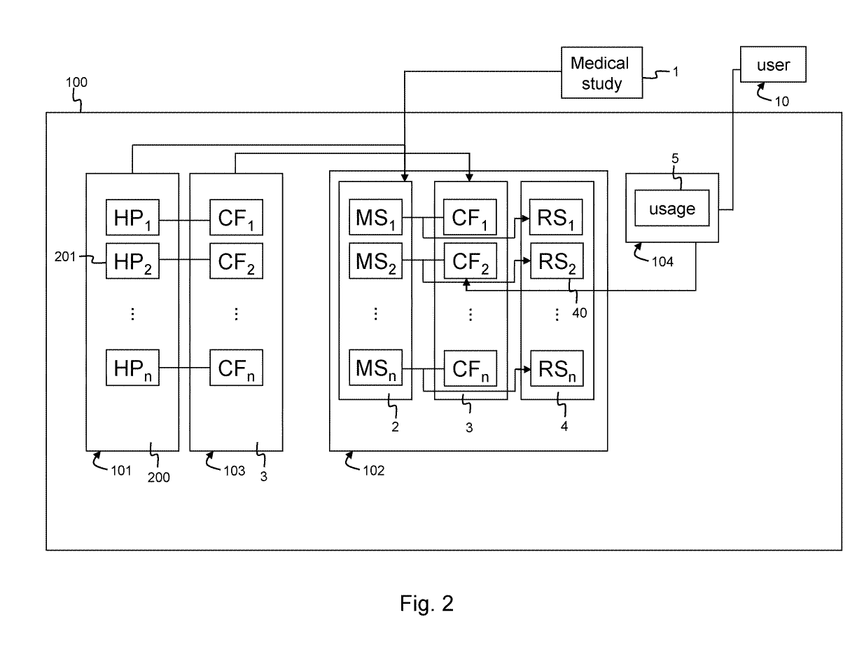

According to a preferred embodiment shown in FIG. 2, a system 100 for automatically selecting a selected hanging protocol 201 for a medical study 1 comprises a hanging protocol memory 101, a credibility memory 103, a selection engine 102 and a usage monitor unit 104. Components having identical reference numbers to components in FIG. 1 or FIG. 2 perform the same function. The usage monitor unit 104 monitors usage 5 by a user 10 of the selected hanging protocol 201, selected by the selection engine 102. The usage 5 corresponds to whether or not the user 10 modifies the selected hanging protocol 201 when analysing the medical study 1. In the example depicted in FIG. 2, the user 10 does not modify the selected hanging protocol 201, i.e. HP₂. In other words, the user does not modify the configuration of HP₂, which is an indication that the user 10 considers the selected hanging protocol 201 as satisfactory for him to perform the analysis of the medical study 1. The usage monitor unit 104 increases the credibility factor 3 of the selected hanging protocol 201, i.e. increases CF₂ of HP₂. As a result, at the next iteration of the method for selecting a hanging protocol, a new calculated relevance score 4 for HP₂ resulting from the combination of a matching score MS₂ and an increased credibility factor CF₂ will be higher than the first RS₂. The probability that the selection engine 102 selects HP₂ as selected hanging protocol 201 for the same type of medical study 1 is increased compared to the first iteration of the method for selecting a hanging protocol.

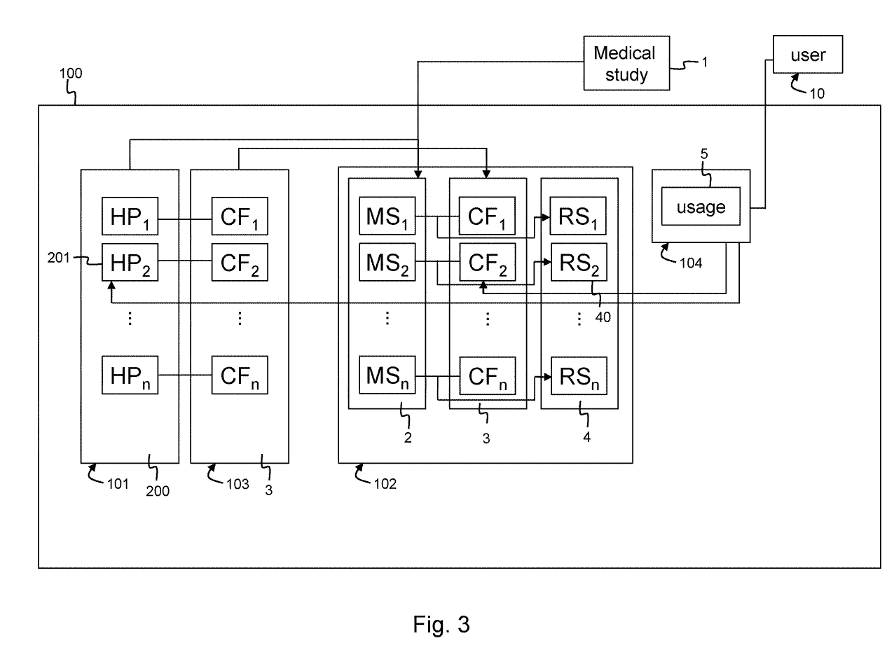

According to a preferred embodiment shown in FIG. 3, a system 100 for automatically selecting a selected hanging protocol 201 for a medical study 1 comprises a hanging protocol memory 101, a credibility memory 103, a selection engine 102 and a usage monitor unit 104. Again, components with reference numbers identical to FIG. 1 perform the same function. The usage monitor unit 104 monitors usage 5 by a user 10 of the selected hanging protocol 201, selected by the selection engine 102. The usage 5 corresponds to whether or not the user 10 modifies the selected hanging protocol 201 when analysing the medical study 1. In the example depicted in FIG. 3, the user 10 modifies the selected hanging protocol 201, i.e. HP₂. In other words, the user modifies the configuration of HP₂, which is an indication that the user 10 does not consider the selected hanging protocol 201 as satisfactory for him to perform the analysis of the medical study 1. The usage monitor unit 104 decreases the credibility factor 3 of the selected hanging protocol 201, i.e. decreases CF₂ of HP₂. As a result, at the next iteration of the method related to the system 100 for the same medical study 1, a new calculated relevance score 4 for HP₂ resulting from the combination of a matching score MS₂ and a lowered credibility factor CF₂ will be lower than the first RS₂. The probability that the selection engine 102 selects HP₂ as selected hanging protocol 201 for the same type of medical study 1 is lowered compared to the first iteration of the method.

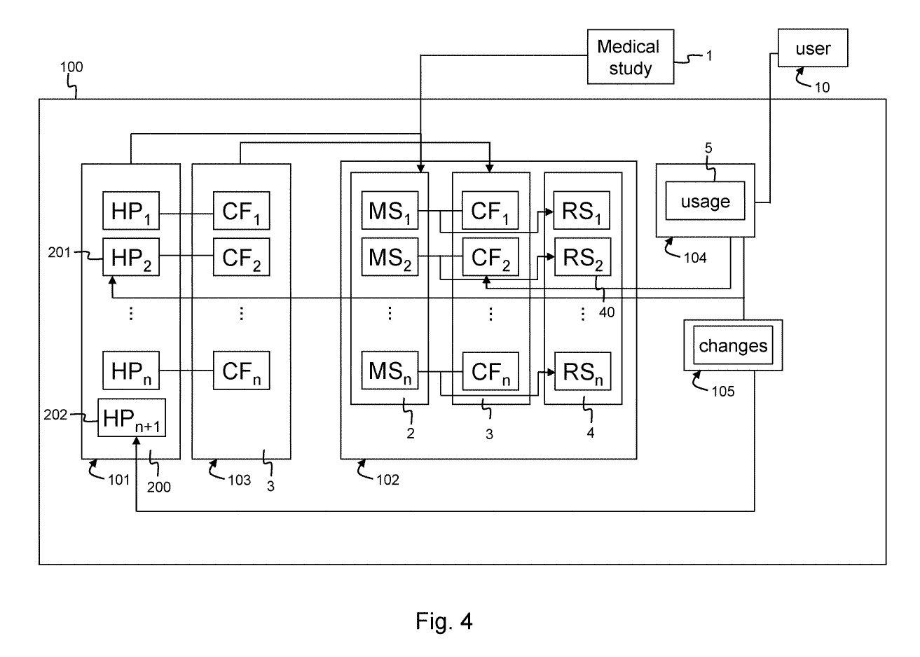

According to a preferred embodiment shown in FIG. 4, a system 100 for automatically selecting a selected hanging protocol 201 for a medical study 1 comprises a hanging protocol memory 101, a credibility memory 103, a selection engine 102, a usage monitor unit 104, and a modification recording unit 105. Components with reference numbers identical to FIGS. 1 to 3 have identical functions. The modification recording unit 105 records changes applied by a user 10 to the selected hanging protocol 201, thereby creating a new hanging protocol 202 and storing the new hanging protocol 202 in the hanging protocol memory 101. In the example depicted in FIG. 4, a new hanging protocol HPₙ₊₁ 202 is created when the user modifies the selected hanging protocol 201, i.e. HP₂. HPₙ₊₁ is a copy of HP₂ that includes the changes applied by the user 10 and that is stored in the hanging protocol memory 101, with n integer higher than 1. The original version of HP₂ stays unchanged and stays stored on the hanging protocol memory 101. The user 10 is referred to as the creator of the new hanging protocol 202.

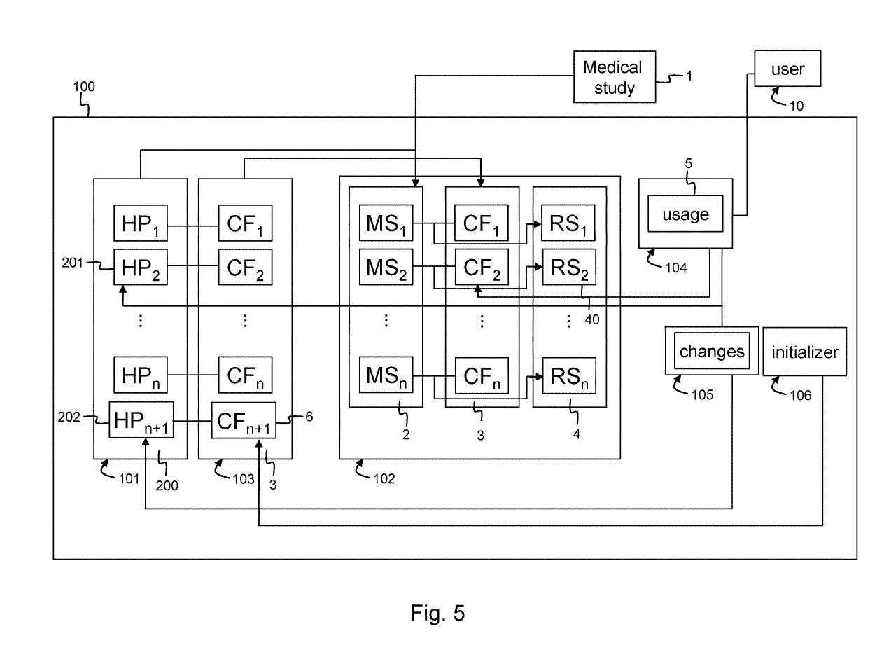

According to a preferred embodiment shown in FIG. 5, a system 100 for automatically selecting a selected hanging protocol 201 for a medical study 1 comprises a hanging protocol memory 101, a credibility memory 103, a selection engine 102, a usage monitor unit 104, a modification recording unit 105, and a credibility factor initializer 106. The credibility factor initializer 106 initializes a new credibility factor CFₙ₊₁ for the new hanging protocol HPₙ₊₁, with n being an integer higher than 1. This new credibility factor 6 of a new hanging protocol 202 initialized to a value that reflects the credibility of the user 10 who is the creator of the new hanging protocol 202, and is calculated from one or more of the following parameters:
the age of the user 10;
the number of medical studies reported by the user 10;
the speed at which the user 10 reports the medical study 1;
the amount of time the user 10 uses the system 100;
the number of hanging protocols 200 stored in the hanging protocol memory 101 and created by the user 10; and
the number of times each of the hanging protocols 200 created by the user 10 has been used without changes.

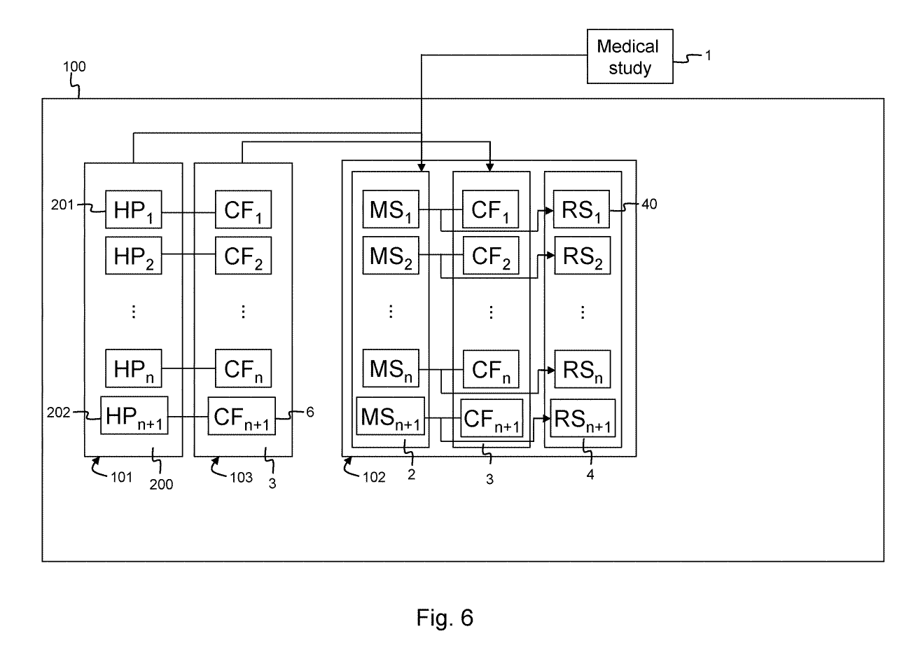

According to a preferred embodiment shown in FIG. 6, a system 100 for automatically selecting a selected hanging protocol 201 for a medical study 1 comprises a hanging protocol memory 101, a credibility memory 103, a selection engine 102, a usage monitor unit 104, a modification recording unit 105, and a credibility factor initializer 106. The preferred embodiment illustrated by FIG. 6 is similar to the preferred embodiment illustrated by FIGS. 1 to 5, except that the hanging protocol memory comprises a new hanging protocol HPₙ₊₁ 202, and that the credibility memory 103 comprises an associated CFₙ₊₁, being the new credibility factor 6. The selection engine 102 compares the same medical study 1 to each of the hanging protocols 200 of the hanging protocol memory 101. A new medical study 1 could also be fed to the system 100. From this comparison results a matching score 2 between each of the hanging protocols 200 of the hanging protocol memory 101 and the medical study 1. For example in FIG. 1, n+1 matching scores 2 are calculated and numbered MS₁, MS₂, to MSₙ₊₁, where n is an integer higher than 1. The selection engine 102 further retrieves from the credibility memory 103 the associated credibility factors 3 of each of the hanging protocols 200. The selection engine 102 then combines the matching score 2 of a hanging protocol and the respective credibility factor 3 of the same hanging protocol. The combination consists for example in calculating the product of the matching score 2 and the credibility factor 3. The combination results in the definition of a relevance score 4. For example in FIG. 1, n+1 relevance scores 4 are calculated from the combination of n+1 credibility factors, numbered CF₁, CF₂, to CFₙ₊₁, and n+1 respective matching scores, numbered from MS₁, MS₂ to MSₙ₊₁, where n is an integer higher than 1. This therefore results in the definition of n+1 relevance scores 4, numbered from RS₁, RS₂, to RSₙ₊₁, where n in an integer higher than 1. The selection engine 2 further classifies the relevance scores 4 of the hanging protocols in increasing order and selects as the selected hanging protocol 201 the hanging protocol for which the relevance score 40 is the highest of all the hanging protocols. In other words, the selected hanging protocol 201 is the one for which the relevance score 40 is maximum amongst all the relevance scores 4 calculated by the selection engine 102. In the example depicted in FIG. 6, the highest relevance score 40 for the medical study 1 is calculated for the hanging protocol HP' of the hanging protocol memory 101. The hanging protocol HP₁ is selected by the selection engine 102, and therefore becomes the selected hanging protocol 201. It is the selected hanging protocol 201 that will be used to displayed images of the medical study 1.

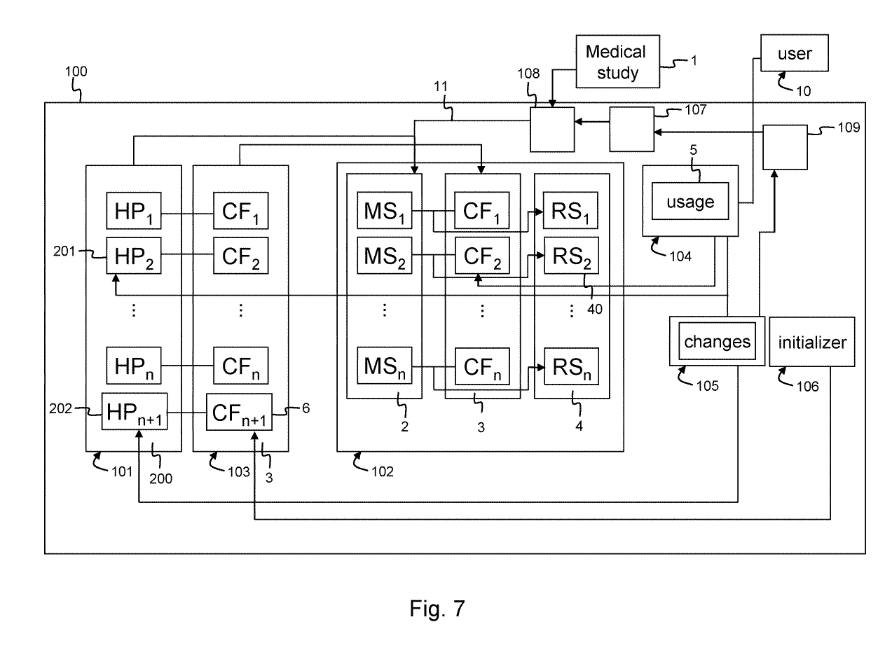

According to a preferred embodiment shown in FIG. 7, a system 100 for automatically selecting a selected hanging protocol 201 for a medical study 1 comprises a hanging protocol memory 101, a credibility memory 103, a selection engine 102, a usage monitor unit 104, a modification recording unit 105, a credibility factor initializer 106, a display rule memory 107, a pre-processing unit 108 and a rule changing unit 109. The pre-processing unit pre-processes the medical study 1 according to display rules 70 stored in the display rule memory 107, thereby creating a pre-processed medical study 11. The selection engine calculates a matching score 2 between the pre-processed medical study 11 and hanging protocols 200 of the hanging protocol memory 101. The selection engine 102 further combines the matching score 2 and the credibility factor 3 for each hanging protocol 200, thereby defining a relevance score 4 for each hanging protocol 200. The selection engine selects the hanging protocol of the hanging protocol memory 101 with the highest relevance score 40 as selected hanging protocol 201. The usage monitor unit 104 monitors the usage 5 of the selected hanging protocol 201 by the user 10. The modification recording unit 105 records a change applied by the user 10 to the selected hanging protocol 201, correcting said pre-processed medical study 11, and thereby creating a new hanging protocol 202 for which a new credibility factor 6 is initialized by the credibility factor initialize 106. The rule changing unit 109 then modifies the display rules 70 according to the changes applied by the user 10 to the selected hanging protocol 201 for the pre-processed medical study 11 and recorded by the modification recording unit 105.

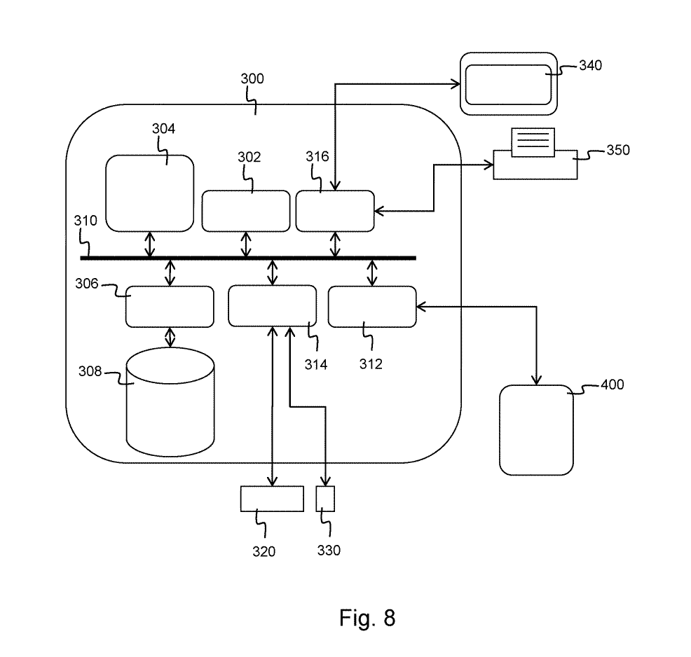

FIG. 8 shows a suitable computing system 300 for hosting the system 100 of FIGS. 1 to 7. Computing system 300 may in general be formed as a suitable general purpose computer and comprise a bus 310, a processor 302, a local memory 304, one or more optional input interfaces 314, one or more optional output interfaces 316, a communication interface 312, a storage element interface 306 and one or more storage elements 308. Bus 310 may comprise one or more conductors that permit communication among the components of the computing system. Processor 302 may include any type of conventional processor or microprocessor that interprets and executes programming instructions. Local memory 304 may include a random access memory (RAM) or another type of dynamic storage device that stores information and instructions for execution by processor 302 and/or a read only memory (ROM) or another type of static storage device that stores static information and instructions for use by processor 304. Input interface 314 may comprise one or more conventional mechanisms that permit an operator to input information to the computing device 300, such as a keyboard 320, a mouse 330, a pen, voice recognition and/or biometric mechanisms, etc. Output interface 316 may comprise one or more conventional mechanisms that output information to the operator, such as a display 340, a printer 350, a speaker, etc. Communication interface 312 may comprise any transceiver-like mechanism such as for example two 1 Gb Ethernet interfaces that enables computing system 300 to communicate with other devices and/or systems, for example mechanisms for communicating with one or more other computing systems 400. The communication interface 312 of computing system 300 may be connected to such another computing system by means of a local area network (LAN) or a wide area network (WAN, such as for example the internet, in which case the other computing system 400 may for example comprise a suitable web server. Storage element interface 306 may comprise a storage interface such as for example a Serial Advanced Technology Attachment (SATA) interface or a Small Computer System Interface (SCSI) for connecting bus 310 to one or more storage elements 308, such as one or more local disks, for example 1TB SATA disk drives, and control the reading and writing of data to and/or from these storage elements 308. Although the storage elements 308 above is described as a local disk, in general any other suitable computer-readable media such as a removable magnetic disk, optical storage media such as a CD or DVD, -ROM disk, solid state drives, flash memory cards, . . . could be used.

The selection engine 102 of the system 100 can be implemented as programming instructions stored in local memory 304 of the computing system 300 for execution by its processor 302. Alternatively the system 100 could be stored on the storage element 308 or be accessible from another computing system 400 through the communication interface 312.

In accordance with a preferred embodiment of the present invention, the combination operation may consist for example in a multiplication of a matching score 2 and a credibility factor 3, but may consist in a sum of a multiplication of a matching score 2 and a credibility factor 3, or a weighted sum of a multiplication of a matching score 2 and a credibility factor 3, etc.

In accordance with a preferred embodiment of the present invention, engines may be realized in software, or hardware or as a combination of thereof.

In accordance with a preferred embodiment of the present invention, it is not necessary that a matching score 2 is calculated for each hanging protocol 200 of the hanging protocol memory 101. Matching scores 2 may be calculated for a pre-selection of hanging protocols, and selected protocol may be chosen out of the pre-selected hanging protocols. The pre-selection can for instance take into account the most recently used hanging protocols, and/or the most frequently used hanging protocols, etc.

Although the present invention has been illustrated by reference to specific preferred embodiments, it will be apparent to those skilled in the art that the invention is not limited to the details of the foregoing illustrative preferred embodiments, and that the present invention may be embodied with various changes and modifications without departing from the scope thereof. The present preferred embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and preferred embodiments of the invention are capable of operating according to the present invention in other sequences, or in orientations different from the one(s) described or illustrated above.

1-14. (canceled)

15. A system for automatically selecting a selected hanging protocol for a medical study, the system comprising:
a hanging protocol memory that stores hanging protocols;
a selection engine that calculates a matching score between each of the hanging protocols and the medical study, the matching score being calculated based on a comparison of characteristics of the medical study with a set of features of each of the hanging protocols; and
a credibility memory that stores a credibility factor for each of the hanging protocols, the credibility factor being derived from a set value inherent to a creator of each of the hanging protocols; wherein
the selection engine combines the matching score with the credibility factor to define a relevance score for each of the hanging protocols; and
the selection engine further selects one of the hanging protocols with a highest relevance score as the selected hanging protocol.

16. The system according to claim 15, further comprising:
a usage monitor that monitors usage of the selected hanging protocol by a user, and that modifies the credibility factor of the selected hanging protocol as a function of the usage.

17. The system according to claim 16, wherein the usage monitor increases the credibility factor of the selected hanging protocol in case the selected hanging protocol is left unchanged by the user.

18. The system according to claim 16, wherein the usage monitor decreases the credibility factor of the selected hanging protocol in case the selected hanging protocol is changed by the user.

19. The system according to claim 18, further comprising:
a modification recorder that records changes applied by the user to the selected hanging protocol to create a new hanging protocol, and to store the new hanging protocol in the hanging protocol memory; and
a credibility factor initializer that initializes a new credibility factor for the new hanging protocol representative of a credibility of the user and that stores the new credibility factor in the credibility memory.

20. The system according to claim 19, wherein the new credibility factor of the new hanging protocol is calculated from one or more of a plurality of parameters including:
an age of the user;
a number of medical studies reported by the user;
a speed at which the user reports the medical study;
an amount of time the user uses the system;
a number of hanging protocols stored in the hanging protocol memory and created by the user; and
a number of times each of the hanging protocols created by the user has been used with and/or without changes applied by other users.

21. The system according to claim 15, further comprising:
a display rule memory that stores display rules for the medical study; and
a pre-processor that pre-processes the medical study according to the display rules to create a pre-processed medical study; wherein
the selection engine further calculates a matching score between each of the hanging protocols and the pre-processed medical study.

22. A method for automatically selecting a selected hanging protocol for a medical study, the method comprising the steps of:
obtaining hanging protocols stored in a hanging protocol memory;
calculating a matching score for each of the hanging protocols by correlating the medical study with the hanging protocols;
obtaining a credibility factor from a credibility memory for each of the hanging protocols;
combining the credibility factor with the matching score for each of the hanging protocols to obtain a relevance score for each of the hanging protocols; and
selecting the hanging protocol with a highest relevance score as the selected hanging protocol.

23. A non-transitory computer readable storage medium comprising computer-executable instructions which, when executed by a computing system, perform the method according to claim 22.
